(19) United States
(12) Patent Application Publication
(10) Pub. No.: US 2026/0148112 A1
(43) Pub. Date: May 28, 2026

(54) METHOD FOR PROVIDING INTERACTIVE COMMUNICATION AGENT SERVICE BASED ON GENERATIVE AI MODEL

(71) Applicant: 42 Maru Inc., Seoul (KR)

(72) Inventors: Dong Hwan KIM, Seoul (KR); You Kyung KWON, Seoul (KR); Han Su KIM, Bucheon-si (KR); Gil Je SEONG, Goyang-si (KR)

(73) Assignee: 42 Maru Inc., Seoul (KR)

(21) Appl. No.: 19/450,155

(22) Filed: Jan. 15, 2026

Related U.S. Application Data
(63) Continuation of application No. PCT/KR2024/010725, filed on Jul. 24, 2024.

(30) Foreign Application Priority Data
Jul. 27, 2023 (KR) 10-2023-0098524
Jul. 24, 2024 (KR) 10-2024-0097793

(51) Int. Cl. G06N 5/04

(52) U.S. Cl. CPC G06N 5/04

(57) ABSTRACT

A method and system for providing an answer to user question by using a generative artificial intelligence (AI) model. In the system for providing an interactive communication agent service based on a generative AI model, the method for providing the service includes the steps of: receiving a user query from a user terminal in a state in which a page associated with a company has been provided to the user terminal; using unique information associated with the user query to identify a specific company related to the user query; and generating an answer to the user query on the basis of the characteristics of the user query by using at least one of a plurality of different answer models.

### TECHNICAL FIELD

The present invention relates to a method and system for providing an answer to a user question by using a generative artificial intelligence (AI) model.

### BACKGROUND

Recently, as artificial intelligence (AI) technology rapidly develops, a language model (for example, ChatGPT) that is capable of natural conversation with a person has emerged.

As such, the language model, unlike an existing chatbot that is manually constructed and provides only limited answers, communicates naturally to a degree similar to a human, shows technological capability that provides fast and accurate information, thereby showing innovation in an artificial intelligence market.

Meanwhile, companies have a need to provide and promote the company's information to customers through various channels such as a company homepage and a company messenger, and are making great efforts to promptly answer requirements or questions of customers about the company.

Therefore, companies are making considerable effort to individually answer inquiries of customers and to promote the company and the company's products and services and the like.

However, such a method causes severe waste of time and manpower and leads to results that are not efficient. In addition, cases frequently occur in which a user receives an unsatisfactory response due to human subjectivity or bias occurring in a process of promoting products or answering inquiries, and cases are occurring in which a prompt and satisfactory answer is not provided depending on the situation.

### SUMMARY

The present invention is directed to providing a method and system for providing an interactive communication agent service specialized for a company.

Further, the present invention is directed to providing a method and system for providing an interactive communication agent service that is capable of providing an accurate and prompt answer to user query (or questioning) about the company.

There is provided a method for providing an interactive communication agent service based on a generative artificial intelligence (AI) model in a system for providing an interactive communication agent service based on a generative AI model, according to the present invention. The method may comprise: receiving a user query from a user terminal, in a state where a page associated with a company is provided to the user terminal; specifying a specific company related to the user query by using unique information associated with the user query; and generating an answer to the user query by using at least one among different plurality of answer models, based on characteristics of the user query, and at least one among the plurality of answer models may be a model that has been trained on the specific company before the user query is received by using data related to the specific company.

In an embodiment, the page associated with the company may comprise a homepage of the specific company, and the user query may be received through a chatbot provided by the specific company.

In an embodiment, the unique information may comprise code information capable of specifying the specific company included in reception path information of the user query, and the specifying may comprise: specifying the specific company by using the code information included in the reception path information of the user query and company code matching information stored in a database of the service providing system.

In an embodiment, the plurality of answer models may comprise a first answer model and a second answer model different from the first answer model, and the first answer model may be a model that is trained by using data related to the specific company and generates an answer through a process of specifying correct answer data for the user query among data related to the specific company, and the second answer model may be a model that generates an answer by using data in which a plurality of questions related to the specific company and an answer to each of the plurality of questions form sets with each other.

In an embodiment, the generating the answer may comprise: generating an answer to the user query by using a large language model (LLM) that receives, as a prompt, an answer generated from at least one of the first answer model and the second answer model; and transmitting the generated answer to the user query to a channel that has received the user query.

In an embodiment, the data related to the specific company may comprise at least one among data registered on a homepage of the company, a document uploaded to the system, a document collected from a server of the specific company, and a document collected from an external website in relation to the specific company, and the first answer model may comprise a Retrieval-Augmented Generation (RAG) model that performs specifying of the correct answer data for the user query by using the data related to the specific company.

In an embodiment, the RAG model may perform a passage search that specifies a portion related to the user query among the data related to the specific company in order to specify the correct answer data.

In an embodiment, the RAG model may specify a location of the correct answer data for the user query among the portions specified through the passage search, and a portion corresponding to the specified location among the portions specified through the passage search and location information about the specified location may be input as a prompt of the large language model.

In an embodiment, the method may further comprise: evaluating a first answer generated from the first answer model and a second answer generated from the second answer model; selecting any one among the first answer and the second answer based on an evaluation result; and inputting any one selected answer as a prompt of the large language model.

In an embodiment, the method may further comprise: generating search queries for respectively deriving answers from the first answer model and the second answer model by using the large language model that receives the user query as a prompt, and a first answer of the first answer model and a second answer of the second answer model may be answers generated by receiving, as inputs, the search queries generated by using the large language model.

In an embodiment, the search queries may comprise information included in at least one category among a first category including keywords extracted from the user query, a second category including a query paraphrased to have a meaning similar to the user query, and a third category including extended terms extended from a meaning of the user query.

In an embodiment, the first answer model may comprise an information retriever and a semantic retriever, and comprise a re-ranker model that calculates a ranking for a search result of the first answer model and a search result of the second answer model.

In an embodiment, the user query may be received through a virtual digital human trained by using data related to the specific company, and an answer to the user query may be output as an utterance of the virtual digital human.

There is provided a system for providing an interactive communication agent service based on a generative artificial intelligence (AI) model, according to the present invention. The system may comprise: a storage unit in which at least one computer program code is stored; and a control unit configured to provide an interactive communication agent service based on the generative AI model, by using the storage unit and the program code, in which the control unit may: receive a user query from a user terminal, in a state where a page associated with a company is provided to the user terminal; specify a specific company related to the user query by using unique information associated with the user query; and generate an answer to the user query by using at least one among different plurality of answer models, based on characteristics of the user query, and at least one among the plurality of answer models may be a model that has been trained on the specific company before the user query is received by using data related to the specific company.

There is provided a program stored on a computer-readable recording medium, executed by one or more processes in an electronic device, according to the present invention. The program may comprise instructions for performing: receiving a user query from a user terminal, in a state where a page associated with a company is provided to the user terminal; specifying a specific company related to the user query by using unique information associated with the user query; and generating an answer to the user query by using at least one among different plurality of answer models, based on characteristics of the user query, and at least one among the plurality of answer models may be a model that has been trained on the specific company before the user query is received by using data related to the specific company.

As described above, the method and system for providing an interactive communication agent service based on a generative AI model according to the present invention may, by using an answer model that has learned data of company, with respect to a customer (or a user) query, provide a prompt and accurate answer to a customer.

Further, the method and system for providing an interactive communication agent service based on a generative AI model according to the present invention may, based on customer's query characteristics, for example, query intention and the like, by selectively using an appropriate answer model among a plurality of answer models, provide a more efficient and accurate answer to a customer.

Further, the method and system for providing an interactive communication agent service based on a generative AI model according to the present invention may, by specifying a correct answer to a customer's query from data of company and by inputting this into a large model to generate an answer, provide a high-reliability company-customized answer to a customer.

### DESCRIPTION OF DRAWINGS

FIG. 1 and FIG. 2 are conceptual diagrams for explaining an interactive communication agent service based on a generative AI model provided in the present invention.

FIG. 3, FIG. 4, and FIG. 5 are block diagrams for explaining a system for providing an interactive communication agent service based on a generative AI model according to the present invention.

FIG. 6 and FIG. 7 are conceptual diagrams for explaining a process of an interactive communication agent service based on a generative AI model provided in the present invention.

FIG. 8 is a flowchart for explaining a method for providing an interactive communication agent service based on a generative AI model according to the present invention.

FIG. 9 is a conceptual diagram for explaining a method for providing an interactive communication agent service based on a generative AI model-based model in which learning for a specific company has been performed, according to the present invention.

FIG. 10 is a conceptual diagram for explaining a prompt that is input to a large language model according to the present invention.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be understood that the accompanying drawings are provided only to easily understand the embodiments disclosed in the present specification, and the technical teachings disclosed in the present specification are not limited by the accompanying drawings, and includes all alterations, equivalents, and alternatives that are included in the teachings and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including”, “having”, and the like are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention is directed to providing a method and system for providing an interactive communication agent service specialized for a company, and is intended to providing a method and system for providing an interactive communication agent service that is capable of providing an accurate and prompt answer with respect to a user query (or questioning) about the company. A service provided according to the present invention is in a ‘Software as a Service’ (SaaS) form, and may be provided for a company that has purchased or subscribed to the service according to the present invention. Further, a service according to the present invention may be provided for a user (or a customer) who has input a user query about a relevant company that has purchased the service according to the present invention.

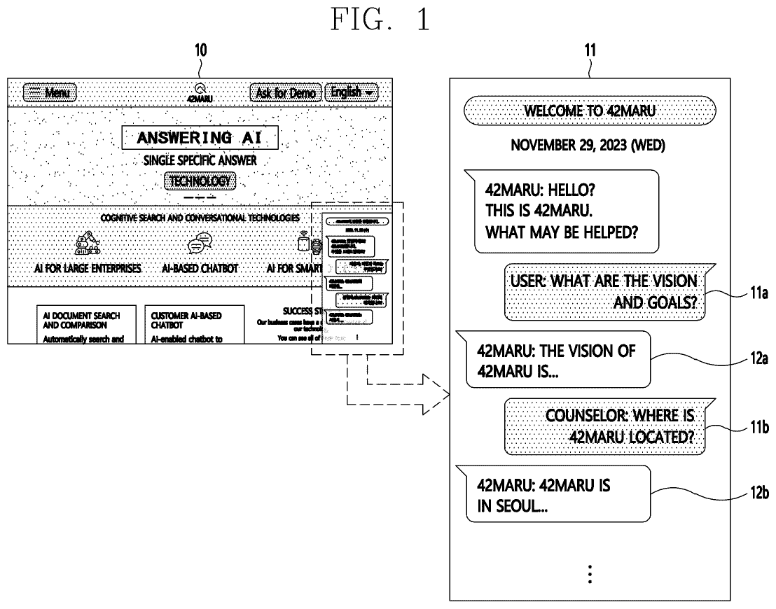

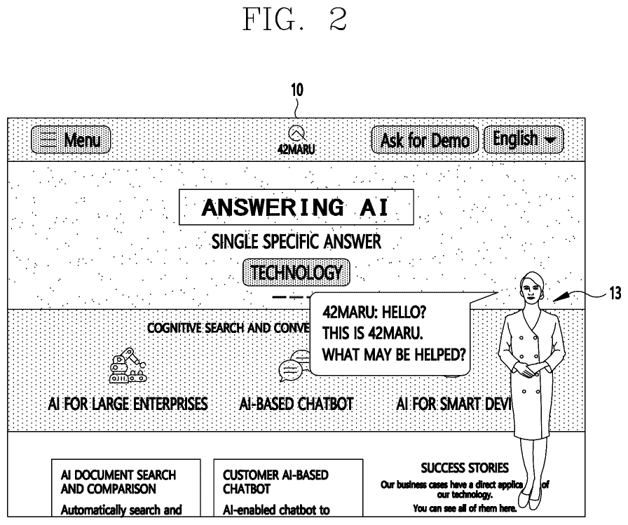

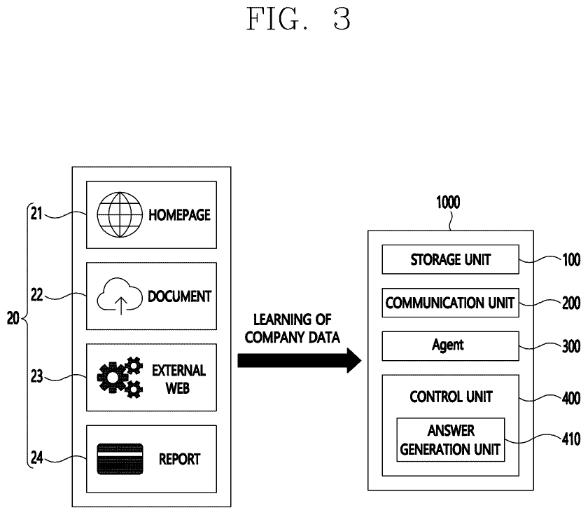

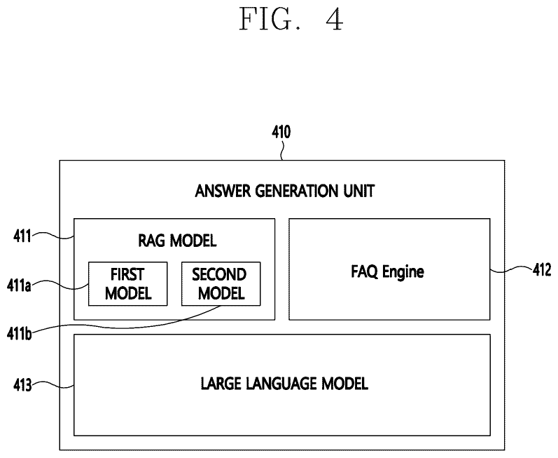

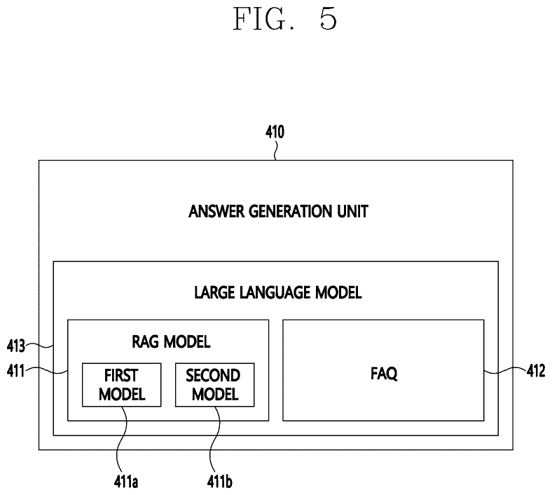

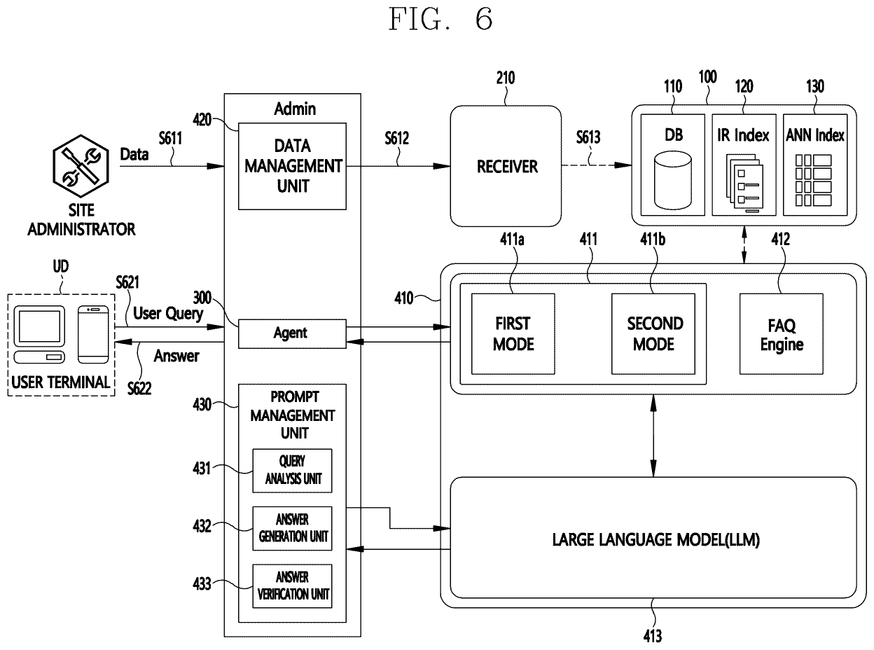

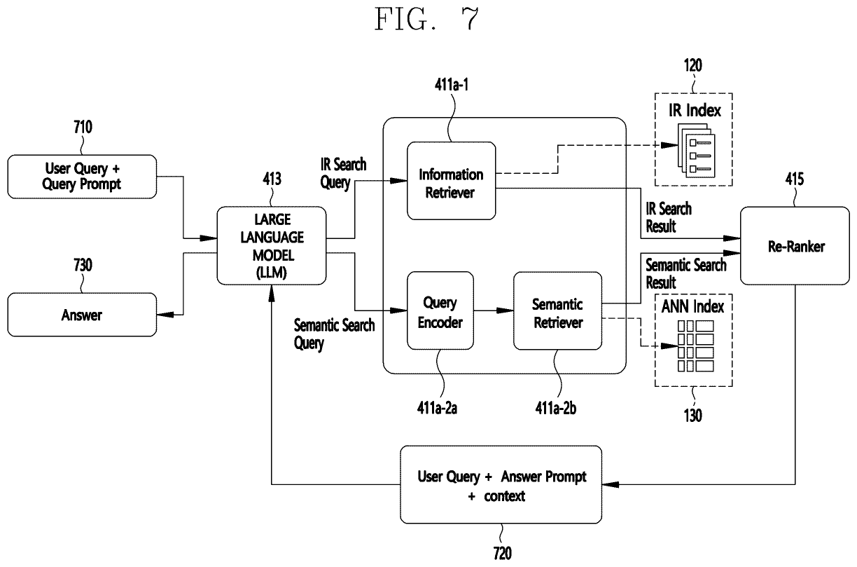

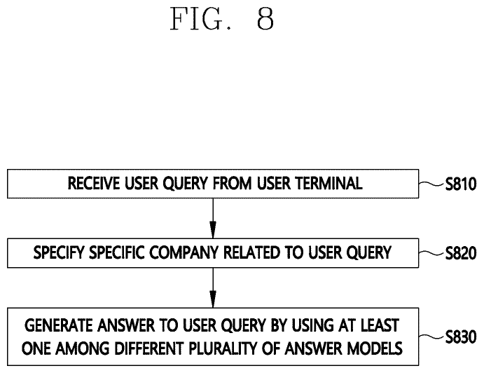

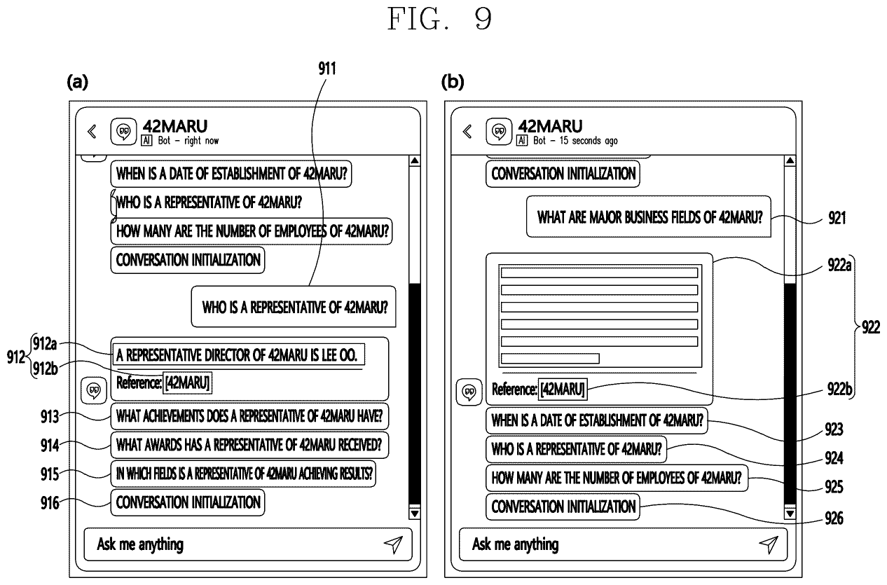

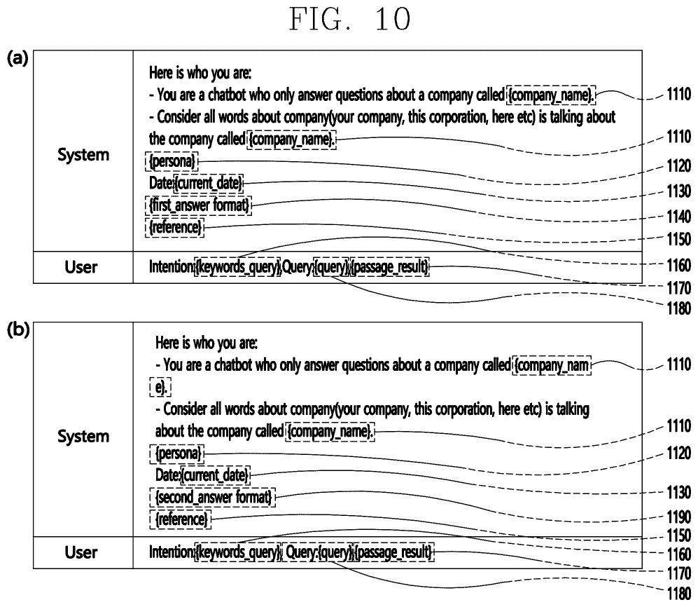

FIG. 1 and FIG. 2 are conceptual diagrams for explaining an interactive communication agent service based on a generative AI model provided in the present invention. FIG. 3, FIG. 4, and FIG. 5 are block diagrams for explaining a system for providing an interactive communication agent service based on a generative AI model according to the present invention, and FIG. 6 and FIG. 7 are conceptual diagrams for explaining a process of an interactive communication agent service based on a generative AI model provided in the present invention. FIG. 8 is a flowchart for explaining a method for providing an interactive communication agent service based on a generative AI model according to the present invention, and FIG. 9 is a conceptual diagram for explaining a method for providing an interactive communication agent service based on a generative AI model-based model in which learning for a specific company has been performed, according to the present invention. FIG. 10 is a conceptual diagram for explaining a prompt that is input to a large language model according to the present invention.

The present invention may be configured such that, through various channels associated with a company, a user query may be received from a user (or a customer), and an answer may be provided to the received user query. As an example of various channels associated with company, for example, various channels associated with company may be a chatbot.

As illustrated in FIG. 1, in examining an example of receiving a user query, a user query may be received through a chatbot 11 provided by a specific company.

In this case, a chatbot may be provided through a homepage of a specific company, or may be provided through other various routes. In the present invention, a chatbot provided on a homepage is illustrated as an example.

Here, a chatbot may mean a software application that may have a natural conversation with a human. A chatbot may be understood as a computer program that understands a user question and automatically responds to the question by simulating a human's conversation using artificial intelligence (AI) and natural language processing (NLP).

In order to construct such a chatbot (or an interactive artificial intelligence system), a technology of “Prompt Engineering” that performs a natural language processing task by utilizing a large (or large-scale, ultra-large) language model (LLM). Hereinafter, for convenience of description, such is referred to as “large language model.”

“Prompt Engineering” means a task of designing (or configuring) an appropriate prompt to obtain a desired outcome from a large language model.

Here, a prompt, as an input value for generating a response (or an answer or a result) from the large language model, includes matters related to an instruction or a command to the large language model, and the large language model generates a response on the basis thereof.

Further, a large language model (LLM), as a model that has been trained based on large-scale language data, is used to perform a natural language processing task (for example, machine translation, text summarization, automatic composition, question answering, and the like) through deep learning algorithms and statistical modeling.

For example, a large language model may include at least one of generative pre-trained transformer (GPT), bidirectional encoder representations from transformers (BERT), and language model for dialog applications (LaMDA).

A large language model used in the present invention may be understood as a model that generates an answer to a user query by receiving as a prompt an answer generated from an answer model that has learned data of company, and transmits the generated answer to a channel that has received the user query.

With reference back to FIG. 1, a user query may be received through a chatbot 11 provided through a homepage 10 of a specific company.

In the present invention, when a user query is received (11a and 11b) through a chatbot 11 provided by a specific company, at least one answer is generated using an answer model that has learned data of the specific company, and an answer 12a and 12b to the user query may be provided using a large language model. Here, a chatbot 11 may be provided on a homepage 10 of a specific company as illustrated. Meanwhile, in the following example, although a description is made of an example in which a chatbot 11 is provided on a homepage 10, the present invention is not limited thereto. That is, a chatbot 11 may be provided not only through a homepage 10 but also through an arbitrary website, various SNS channels, various messenger platforms, and the like. In addition, a chatbot 11 may also be provided on a metaverse. Here, an arbitrary website may include various kinds of information-providing sites, portal sites, and the like. An information-providing site, as a site capable of providing information of various companies, when a user query about a specific company is input through a chatbot 11, etc. at the information-providing site, the information-providing site may provide an answer to the user query. In this case, companies to which information is provided at an information-providing site may be specified as companies that have agreed to provide information to users at the information-providing site.

A chatbot 11 may be provided to users through various routes, and, for example, may be installed (or plugged in) on a homepage 10 of the company and may be provided to users who have accessed the homepage of the company. An administrator of the company may access an administrator page of a system 1000 and may perform a series of processes (e.g., input of company homepage 10 information, chatbot 11 name, greetings, persona settings, colors, icons, chatbot 11 screen position, size, and input of various information, and the like) to register a chatbot 11 on a homepage 10 of the company.

Meanwhile, a user may enter a company channel or a homepage and may access a chatbot 11. For example, a user may, using a user terminal, select a chatbot 11 access icon provided on a homepage and may connect to a chatbot 11. Further, on a homepage, a chatbot 11 interface may also always be provided.

The system 1000, when specification (or identification) of a user who has connected to a chatbot 11 is possible, may store the user's past conversation history and, when the user connects again to the chatbot 11, may provide the past conversation session to the chatbot 11. A chatbot 11 may also be configured to receive user information (name, affiliation, age, gender, email, phone number, etc.).

A user query and an answer may be matched to user information and may be stored in the system 1000, and in the system 1000, a user query received from a specific company and an answer thereto may form a pair and may be continuously updated as company data.

Meanwhile, in the present invention, a digital human that has been trained using data related to a specific company may also receive a user query through a digital human.

A digital human may be understood as a virtual human created by utilizing digital technologies (for example, computer graphics (CG)) technology.

For example, as illustrated in FIG. 2, the present invention may provide an environment in which a digital human 13 is displayed to be overlapped on one area of a specific company homepage 10 may provide an answer to a user query while uttering.

As such, in the present invention, by utilizing a generative artificial intelligence (AI) model, a service that may provide an answer to a user question may be provided.

Hereinafter, together with the accompanying drawings, a more specific description will be made of a system for providing an interactive communication agent service based on a generative AI model according to the present invention.

FIG. 3 is a conceptual diagram for explaining a system for providing an interactive communication agent service based on a generative AI model according to the present invention. Hereinafter, for convenience of description, “a system 1000 for providing an interactive communication agent service based on a generative AI model” will be referred to as a “system 1000”. The system 1000 according to the present invention may also be understood as a platform.

As illustrated in FIG. 3, the agent service providing system 1000 according to the present invention may be configured to include at least one among a storage unit 100, a communication unit 200, an agent 300, and a control unit 400.

The storage unit 100 is configured to include at least one memory, may also be referred to as a database (DB), and may be made to store various information related to the present invention. In the present invention, the storage unit 100 may be provided in the agent service providing system 1000 itself. In addition, at least a part of the storage unit 100 may be configured as a cloud server (or a cloud storage). That is, the storage unit 100 may be understood to be sufficient as a space in which data and instructions necessary for operation of the agent service providing system 1000 according to the present invention are stored, and to have no restrictions on a physical space.

In the storage unit 100, company data 20 of various companies that use or subscribe to the system 1000 according to the present invention, or various companies that use or subscribe to a platform provided through the system 1000, may be stored. Company data of the storage unit 100 may exist to be stored separately by the company.

In the storage unit 100, various company data related to at least one company may be stored. For example, company data may include at least one among various information posted on a homepage of the company (for example, data registered on a homepage of the company), disclosure materials of the company, credit evaluation materials of the company, recruitment information of the company, latest news about the company, an interview of a representative director of the company, press releases about the company, reports related to the company, service introduction materials of the company, materials related to products of the company, and product user manuals of the company. However, the above-described company data are merely one example, and in the present invention, company data for training an answer model are not limited in kind.

As illustrated in FIG. 3, company data 20 may exist to be stored in various storages such as an internal server of the company, a homepage of the company, an external web, and an external server, and, in the system 1000 according to the present invention, may be collected through various methods and may be stored in the storage unit 100.

The system 1000 may collect external data stored in various storages and may store company data separated by company in the storage unit 100. In this case, the system 1000 may collect data associated with the company among external data by using main data related to the company such as the company name or a representative of the company as an entity, and may store the data as company data.

For example, the system 1000 may specify the company through entity extraction from external data. As one example, the system 1000 may analyze news articles to extract the company name and may collect contents about events or activities related to the company as company data. As another example, the system 1000 may extract the company name mentioned in social media through analysis of social media such as Twitter and Facebook, may analyze public opinion, and may collect the corresponding data as company data. As another example, the system 1000 may extract the company name from a dataset of public data provided by a government or a public institution, may analyze this to identify a specific company, and may collect the identified data as company data. Another example, the system 1000 may crawl news articles to collect articles related to the specific company, may extract the company name through text analysis techniques, may, based on the extracted company name, identify major activities, stock price fluctuations, management changes of the company, and the like, and may collect the corresponding data as company data. As another example, the system 1000 may crawl data of an electronic disclosure system such as DART, and may crawl and collect data such as financial statements, business reports, and audit reports provided by the DART system. The system 1000 may analyze the collected data to evaluate the company's financial condition, management performance, and the like, and may collect the corresponding data as company data. For example, the system 1000 may analyze recent quarterly results of the specific company, may compare indicators such as sales, operating profit, and net income, may forecast a future management outlook, and may store the corresponding data as company data.

As another example, the system 1000 may utilize overseas disclosure data, and may crawl and collect disclosure data provided by the SEC (U.S. Securities and Exchange Commission) EDGAR system. The system 1000 may analyze financial statements, shareholders'meeting reports of overseas companies, and the like to grasp global market trends. For example, the system 1000 may analyze performance data of global competitors to evaluate competitiveness of the company itself, may establish strategies, and may store this as company data.

As another example, the system 1000 may crawl and collect company evaluation reports provided by securities firms and credit rating agencies, and may analyze the collected evaluation reports to evaluate the company's creditworthiness, investment grade, position within an industry, and the like. For example, the system 1000 may analyze changes in credit rating of the specific company to evaluate investment risk, and may store opinions on investment decisions as company data. The above-described data may be stored separately by the company in the storage.

Further, in the storage unit 100, data, instructions, and program codes necessary for operation of the system 1000 may be stored. For example, in the storage unit 100, training data necessary for training an answer model may be stored, instructions implemented to train the answer model, and program codes necessary to provide a service according to the present invention may be stored.

The communication unit 200 is connected with servers and devices and the like through a wireless or wired network and may be implemented to receive or transmit overall data and information necessary for the system 1000.

In addition, the communication unit 200 is communicatively connected with a user terminal and may receive a user query from the user terminal. For example, as illustrated in FIG. 1, the communication unit 200 may receive a user query (e.g., “What are the vision and goals?”, 11a) input from the user terminal.

Here, the user terminal may mean at least one among a mobile phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), or a head mounted display (HMD)).

Further, the communication unit 200 may support various communication methods according to communication standards of a communicating device.

For example, the communication unit 200 may be configured to communicate with at least one among a user terminal, a server, and a device (including a cloud server) by using at least one among wireless LAN (WLAN), wireless fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), fifth generation mobile telecommunications (5G), Bluetooth™, radio frequency identification (RFID), infrared communication (infrared data association (IrDA)), ultra-wideband (UWB), ZigBee, near field communication (NFC), and wireless universal serial bus (wireless USB) technologies.

The agent 300 performs communication and interaction between a user terminal and the system 1000, and, for example, may include a chatbot that receives a user query from a user terminal, a digital human that converses with a user terminal (or a user), or the like. the agent 300, like a chatbot or a digital human, performs communication between the system 1000 and a user terminal, may receive a user query, and may perform a role of delivering to an answer generation unit 410 of the system 1000. Further, the agent 300 may be configured to provide to a user terminal an answer generated at the answer generation unit 410.

In the present invention, the agent 300 is implemented in various forms and may provide to a user terminal an answer generated from an answer model. As illustrated in FIG. 1, the agent 300 is implemented in a chatbot form and may provide an answer to a user query. As another example, as illustrated in FIG. 2, the agent 300 may provide an answer to a user query in a digital human 13 (or virtual human) form. In this case, a chatbot 11 or a digital human 13 may be provided through various channels of company and, as illustrated in FIG. 1 and FIG. 2, may be provided on a homepage 10 of company. In addition, the agent 300 does not impose great restrictions on a type as long as it is a channel capable of communicating with a user, such as a messenger and an AICC (AI (Artificial Intelligence) CONTACT CENTER), which are operated separately from a homepage 10 of the company.

Meanwhile, a control unit 400 according to the present invention may perform a series of processes related to the present invention and may perform a role of controlling overall operations of an agent service providing system 1000.

Specifically, the control unit 400 may perform a series of data processing to process signals, data, information, and the like that are input or output through the components examined above or to provide or process appropriate information and functions to a user. The control unit 400 may also be understood as at least one processor, and a processor may mean a CPU or a GPU.

Functions of elements disclosed in the present invention may be implemented as a circuit or a processing circuit including a controller, a computer, a processor, and the like. For example, since processors include transistors and other circuits in themselves, processors may be a processing circuit or a circuit.

Meanwhile, data processing and functions processed by the system 1000 and the control unit 400 according to the present invention may be implemented as a computer program or instructions, code, etc. A computer program, instructions, and code and the like should be understood to include software for a programmable processor or firmware, such as commands to a processor or structural arrangements for a fixed-function device, a gate array, or a programmable logic device.

A computer program may be stored in a memory through any suitable delivery mechanism, for example, a computer-readable storage medium, a computer program product, and the like. In addition, a delivery mechanism may be a signal configured to reliably deliver a computer program through air or through an electrical connection.

Computer program instructions and code and the like provide logic and routines that enable a device to perform methods of the present invention. A processor may read a memory, may load a computer program, and may execute.

Meanwhile, the control unit 400, when receiving a user query, may provide an answer corresponding to the user query based on company data of a specific company stored in a storage unit 100.

A method of generating an answer to a user query in the system 1000 according to the present invention will be examined in more detail. As illustrated in FIG. 4 and FIG. 5, the answer generation unit 410 according to the present invention may include a plurality of answer models (or a plurality of answer generation units, 411, 412). A plurality of answer models, as different answer models, may be configured as models in which methods of generating an answer are different from each other. The answer generation unit 410 according to the present invention may include at least one answer model in which learning has been performed using company data.

Further, the answer generation unit 410 may further include a large language model 413. A large language model may generate an answer to a user query by receiving as a prompt an answer generated at at least one of the plurality of answer models 411 and 412. In the present invention, the term “large language model 413” may also be used interchangeably with “large answer model.”

As such, the answer generation unit 410 may generate the answer to the user query by using the large language model 413 that receives as a prompt an answer generated from at least one of a first answer model 411 and a second answer model 412. Further, an answer to the generated user query may be transmitted to a channel that has received the user query. In this case, a role of transmitting an answer to a user query to a channel that has received the user query may be performed in cooperation by a communication unit 200 and the agent 300.

Meanwhile, the answer generation unit 410 of the present invention, as illustrated in FIG. 4, may be configured as respective models of a plurality of answer models (e.g., a first answer model 411, a second answer model 412) and the large language model 413. Further, differently from this, as illustrated in FIG. 5, the large language model 413 may also be configured to include a plurality of answer models (e.g., the first answer model 411 and the second answer model 412). Further, any one of the plurality of answer models may be the large language model 413 itself.

Any one (e.g., the first answer model 411) of the plurality of answer models according to the present invention may be a model that is trained by using data related to a company and generates an answer through a process of specifying correct answer data for a user query among data related to the company. Here, the company may be a specific company that has purchased or subscribed to a service according to the present invention.

In the present invention, the first answer model 411 may include a first model 411a, and the first model 411a may be implemented to search from company data of a company at which a user query is received text fragments (phrases or paragraphs, that is, passages) having high relevance to the user query. The first model 411a may be implemented to specify a portion (or a phrase) related to the user query from company data. The first model 411a may perform a passage search that specifies a portion related to the user query among data related to a specific company at which the user query is received. The first model 411a may be a model for which training on company data is performed before a user query is received.

In addition, the first answer model 411 may include a second model 411b. The second model 411b may be implemented to extract and analyze information from text data to provide a relevant answer to a user query.

The second model 411b may analyze a specific portion related to the user query specified from the first model 411a among company data and may generate an answer to the user query. The second model 411b may be capable of specifying a location of the correct answer data for the user query among portions specified through the passage search. In this case, the second model 411b may generate, as an answer of the second model 411b, at least one of a portion corresponding to the specified location among the portions specified through the passage search and location information about the specified location. Such an answer of the second model 411b may be input as a prompt of the large language model.

Meanwhile, the first answer model 411 may include a Retrieval-Augmented Generation (RAG) model 411, and the first model 411a and the second model 411b examined above may be included in the RAG model 411. The RAG model 411, as a model having combined information search (retrieval) and answer generation, in the present invention, may have a role of information search performed by the first model 411a and a role of answer generation performed by the second model 411b. The first answer model 411 and the RAG model 411 may be understood as the same model, and thus the same drawing reference numeral may be used.

The RAG model 411 may perform a role of specifying the correct answer data for the user query by using data related to a specific company at which the user query is received. The RAG model 411, by including the first model 411a and the second model 411b, may perform a passage search that specifies a portion related to the user query among data related to a specific company at which the user query is received, in order to specify the correct answer data for the user query. In addition, the RAG model 411 may specify a location of the correct answer data for the user query among the portions specified through the passage search. Further, a portion corresponding to the specified location among the portions specified through the passage search and location information about the specified location may be input as a prompt of the large language model 413.

Further, among a plurality of answer models according to the present invention, another one (e.g., a second answer model 412) may be a model that generates an answer by using data in which a plurality of questions related to a company and an answer to each of the plurality of questions form sets with each other. Here, the company may be a specific company that has purchased or subscribed to a service according to the present invention. Here, the second answer model 412 may be configured as a Frequently Asked Questions (FAQ) engine. An FAQ engine 412, as an engine that automatically provides an answer to frequently asked questions for the company to which a user query is input, may promptly and accurately answer repetitive and general questions of users. In a database, frequently asked questions may exist pre-registered as standard queries, and pairs of a standard query and an answer corresponding thereto may exist in pre-registered form.

The FAQ engine 412 may search for and provide an answer to a user query by using an answer to a standard query (e.g., frequently asked questions or expected queries) constructed (registered) in the system 1000. The FAQ engine 412 may select a standard query and may provide an answer to the standard query by generating a similar question (query) for a user query by using a paraphrasing technique.

Hereinafter, based on the description examined above, together with FIG. 6 to FIG. 10, a more specific examination will be made of a process of generating an answer to a user query.

First, as illustrated in FIG. 6, in the present invention, through access to the system 1000 by a site administrator (e.g., a person in charge of a company) of a company using a service according to the present invention, company data necessary to train an answer model examined above and to generate an answer to a user query may be received. The system 1000 may manage data of a company through a data management unit 420. The data management unit 420 may be included in the control unit 400. The data management unit 420 may receive data stored in a data storage (e.g., a PC of the company, a server, a cloud server, and the like) of the company through a receiver 210 (S612), and the data management unit 420 may store data of the company in a storage unit 100 of the system 1000. The storage unit 100 may include a database 110 in which data of the company are stored, an IR (Information Retrieval) Index 120 for data of the company, and an ANN (Approximate Nearest Neighbor) Index 130 for data of the company.

The IR Index 120, as data designed to search an answer (or information) to a user query from company data, when a query is received by a user, the answer generation unit 410 may use the IR Index 120 to search a document or an answer related to a user query. In the present invention, a specific description of the IR Index 120 may detract from understanding the nature of the invention, and thus the IR Index 120 will be understood at an ordinary technical level.

An ANN (Approximate Nearest Neighbor) Index 130, as a data structure used to quickly and efficiently find an item most similar to a user query from company data, is used to find a nearest neighbor particularly in a high-dimensional data space, and complex indexing for various data types such as images, text, and audio is possible. In the present invention, a specific description of an ANN Index may detract from understanding the nature of the invention, and thus an ANN Index shall be understood at an ordinary technical level.

As such, in the present invention, when company data are received (or uploaded) in the system 1000, the IR Index 120 and the ANN Index 130 for company data may be generated through analysis and preprocessing for company data. Further, the IR Index 120 and the ANN Index 130 may be used at the answer generation unit 410 to specify (or search) data related to a user query in order to generate an answer to a user query.

As such, in a state in which preprocessing for company data is performed, as illustrated in FIG. 6 and FIG. 8, a process according to a process (S810, S621) of receiving a user query from a user terminal, a process (S820) of specifying a specific company related to the received user query, and a process (S830) of generating an answer to the received user query by using at least one among different plurality of answer models may proceed sequentially.

Here, in a process of receiving a user query from a user terminal UD of FIG. 6, as examined above, a user query may be received from a page associated with the company or from various channels related to the company. Reception of a user query may be performed through the agent 300, and, as examined above, such the agent 300 may be implemented in a chatbot form.

In this case, pages associated with the company may include a homepage (homepage) of the specific company, a product sales page of the specific company, a shopping mall page, and the like. The user query may be received through the agent 300 corresponding to a chatbot (chatbot) provided through a homepage of the specific company. Further, as described above, the agent 300 may provide an answer to a user query in a digital human (or virtual human) form. In addition, the agent 300 does not place great restrictions on a type as long as it is a channel capable of communicating with a user, such as a messenger and an Artificial Intelligence (AI) CONTACT CENTER (AICC), which are operated separately from a homepage of the company.

As such, when a user query is received, a process of specifying the specific company related to the user query may proceed. The control unit 400 may specify the specific company related to the user query by using unique information associated with the user query. In the system 1000, a plurality of companies that use a service according to the present invention are registered, and in a storage unit 100, information about the plurality of companies registered in the system may be included. Specification of each company is made based on unique information assigned to each company, and in a database of the storage unit 100, matching information in which a company and unique information of the company are matched with each other may exist. Meanwhile, a user query is received from a user terminal, and together with the user query, reception path information in which the user query is received is further received, and the reception path information may include unique information of a company capable of specifying the company. Unique information of the company may include code information capable of specifying the specific company included in the reception path information of the user query. Here, code information may also be understood as identification information capable of specifying or identifying the company, and as an ID of the company, or the like.

Here, reception path information may include URL information in which a user query is received, and the URL information may include unique information of the company. The control unit 400, when code information is received together with a user query, may specify which company among the plurality of companies registered in the system the user query is, by using the received code information and matching information stored in the database. Further, the control unit 400 may generate an answer dependent on the specified company with respect to a user query. When an answer is generated, the generated answer, the agent 300 may transmit the generated answer to a user terminal UD (S622).

Meanwhile, the control unit 400, when a user query is received and the company is specified, may generate an answer through the answer generation unit 410 by using company data of the specified company. The control unit 400 may generate an answer to a user query by using at least one of different plurality of answer models (S830). As illustrated in FIG. 6, the agent 300 may deliver the received user query to the answer generation unit 410.

Meanwhile, among a plurality of answer models, whether which answer model generates an answer to a user query may be determined by various criteria. The control unit 400 may, based on any one among the various criteria, i) select any one of a plurality of answer models to generate an answer, or ii) generate respectively answers by using all of the plurality of answer models and then select any one answer, or iii) first generate an answer with respect to any one of the plurality of answer models and then determine whether to generate an answer with a next model according to accuracy of the generated answer.

Here, the various criteria may be determined based on characteristics of a user query. The control unit 400, according to characteristics of a user query, among a plurality of answer models, may select at least one answer model suitable for characteristics of the user query, and, with the selected answer model, may generate an answer to the user query.

Here, characteristics of a user query may include query intention corresponding to the user query, a query format according to the user query, and the like, and the control unit 400 may analyze characteristics of the user query, determine which answer model is suitable for the intention, and select a specific answer model according to a determination result.

Here, a query format, as whether a query according to a user query corresponds to HOW or WHY, the control unit 400, when a query format according to a user query is a query corresponding to HOW or WHY (e.g., “How did 42maru achieve such rapid growth?”, “Why are you relocating the headquarters?”), may use a first answer model 411 or the large language model 413, and otherwise may use a second answer model 412 configured as an FAQ engine.

In addition, the control unit 400 may, according to characteristics of a user query, learn which answer model yields high accuracy for an answer, and may select a specific answer model that derives a result value of high accuracy among a plurality of answer models. In this case, the control unit 400 may receive user feedback about answers provided to a user terminal and may continuously train which answer model has high accuracy according to characteristics of a user query.

In addition, the control unit 400 may determine which answer model to use by a query category or by an appropriate answer format according to a query (e.g., short-answer/list/subjective type, etc.).

Which answer model to select at the control unit 400, and in what order answers are generated from answer models, may be determined based on data obtained through learning based on deep learning.

As described above, in the present invention, based on various criteria according to characteristics of a user query, i) any one of a plurality of answer models may be selected to generate an answer, or ii) after respectively generating answers by using all of the plurality of answer models, any one answer may be selected, or iii) after first generating an answer with respect to any one of the plurality of answer models, it may be determined whether to generate an answer with a next model according to accuracy of the generated answer.

Meanwhile, in cases of i) and iii), the control unit 400 (or the answer generation unit 410) may specify any one answer model among a plurality of answer models that will preferentially generate an answer, and may perform verification for a result value, that is, an answer obtained from any one answer model. Further, the control unit 400, as a result of verification, when the result value corresponds to an appropriate answer corresponding to a user query, with the result value, may specify an answer to the user query. Alternatively, the control unit 400, when the result value is not an appropriate answer corresponding to a user query, may generate an answer to a user query by using, among a plurality of answer models, a next-priority answer model different from the preferentially specified answer model, and may perform verification for a result value, that is, the generated answer. Further, as a result of verification, when an answer of the next-priority answer model corresponds to an appropriate answer corresponding to a user query, this may be specified as an answer to the user query. Similarly, when an answer generated from the next-priority answer model is not an appropriate answer corresponding to a user query, remaining answer models may be used to generate an answer. In addition, when there no longer exists an answer model that generates an answer or when a plurality of answers are obtained from at least two answer models, the control unit 400 may combine a plurality of answers, that is, a plurality of result values, and may use a combined result as a final answer corresponding to a user query. In this case, the control unit 400 may, based on various criteria, set differently weights for a plurality of result values, and may generate a final answer to a user query by combining a plurality of result values according to the weights.

Meanwhile, criteria for determining whether an appropriate answer to a user query are very diverse, and based on natural language processing technology or deep learning technology, based on meaning, intention, context, and the like of a user query, may mean determining whether an answer generated from an answer model, that is, a result value, is appropriate. Accordingly, natural language processing technology or deep learning technology to be utilized may be very diverse, and in the present specification no special limitation is placed thereon.

Meanwhile, in a case of ii), the control unit 400 may respectively generate answers in a plurality of answer models, may compare the generated answers, may select a priority answer, and may generate an answer to a user query. In this case, a priority answer may be determined based on meaning, intention, and context of a user query, or may be determined on the basis of various criteria such as accuracy, answer format, and question format.

As another example, the control unit 400 may, based on a type, a category, or a topic of a question corresponding to a user query, select at least one answer model among a plurality of answer models.

Meanwhile, the system 1000 according to the present invention may further include a prompt management unit 430. The prompt management unit 430, as a role of generating a prompt input to the large language model 413, may generate a prompt input to the large language model 413.

A prompt input to the large language model 4130 may be configured in different formats according to a result value to be obtained.

The prompt management unit 430 may include at least one among a query analysis unit 431, an answer generation unit 432, and an answer verification unit 433.

The query analysis unit 431, by using a user query, so that a query prompt for the user query is generated, as illustrated in FIG. 7, may input a user query and a query prompt 710 to the large language model 413.

A result derived by inputting a user query and a query prompt 710 to the large language model 413 may be referred to as a search query, an extended user query, an extended result, or the like. A search query may be configured in a format or may include contents so that each answer model better understands a user query in order for an answer model to generate or search an answer to a user query.

As such, the query analysis unit 431 may generate search queries to respectively derive answers from a first answer model 411 and a second answer model 412 by using the large language model 413 that receives a user query and a query prompt as a prompt.

In this case, here, a first answer of the first answer model 411 and a second answer of the second answer model 412 may be constituted as answers generated by receiving, as inputs, the search queries generated by using the large language model 413. Meanwhile, a query prompt may be constituted of a plurality of formats that generate respective search queries corresponding to a plurality of categories. For example, a first category may be configured to include keywords extracted from a user query, and a second category may be configured as a similar user query having a meaning similar to a user query. Further, a third category may include a third search query composed of an extended user query having a meaning extended from a user query.

As such, the query analysis unit 431 according to the present invention may configure a prompt so that a first search query, a second search query, and a third search query for first to third categories are obtained, and may input to the large language model 413. Meanwhile, in addition to the examples examined above, the plurality of categories may be configured in various ways.

Meanwhile, when a first search query, a second search query, and a third search query are obtained, the control unit 400 may input at least some of these to the first answer model 411 or the second answer model 412, and may obtain, from at least one of the first answer model 411 and the second answer model 412, an answer (or a search result, a result value) for a user query. Here, the first answer model 411, as a RAG model 411 as examined in FIG. 4 and FIG. 5, may obtain an answer to a user query by receiving at least some of a first search query, a second search query, and a third search query as inputs.

A first model 411a constituting a RAG model 411 may, as illustrated in FIG. 7, include at least one among an information retriever 411a-1 and a semantic retriever 411a-2b. Search results searched at each of the information retriever 411a-1 and the semantic retriever 411a-2b may be input to a re-ranker (or a re-ranker model, or a ranking calculation unit) 415. A re-ranker model 415 may, by comparing a search result (or a first search result) at the information retriever 411a-1 and a search result (or a second search result) at the semantic retriever 411a-2b, specify a search result having high similarity to a user query among the first search result and the second search result. Further, some search results having high similarity to the user query among the first search result and the second search result may be processed as inputs of a second model 411b of the RAG model 411.

More specifically, the information retriever 411a-1 of the first model 411a may have input, as illustrated in FIG. 7, an IR search query that includes a first search query, which is a first category composed of keywords extracted from a user query, and a third search query composed of keywords extended from a user query. As such, to the information retriever 411a-1, an IR search query composed of only the first search query and the third search query is input. In this case, the IR search query may not include a user query.

The information retriever 411a-1 of the first model 411a may search information corresponding to the IR search query by using an IR Index 120. An IR search result, which is a result (the first search result) searched at the information retriever 411a-1, as examined above, may be input to the re-ranker 415 in order to calculate a ranking between a Semantic Search Result, which is a result (the second search result) searched at the semantic retriever 411a-2b, and the IR search result.

Next, a semantic retriever 411a-2b of the first model 411a may receive a second search query, which is a second category composed of a similar user query having a meaning similar to a user query. The semantic retriever 411a-2b may input a semantic search query, including the second search query and a user query received from a user terminal, to a query encoder 411a-2a of the first model 411a. The query encoder 411a-2a may process the semantic search query into a language understandable by the semantic retriever 411a-2b. The semantic search query may be input to the semantic retriever 411a-2b through the query encoder 411a-2a. The semantic retriever 411a-2b may specify a portion corresponding to the semantic search query among company data by using an ANN Index 130. The specified portion herein may be understood as a search result (the second search result or also expressible as a Semantic Search Result) of the semantic retriever 411a-2b.

Further, the specified portion, that is, the second search result, may be input to the re-ranker 415. The re-ranker 415 may, by receiving a result (the first search result or the IR search result) searched at the information retriever 411a-1 and a result (the second search result or the Semantic Search Result) searched at the semantic retriever 411a-2b, calculate a ranking between the first search result and the second search result. Further, in the present invention, some search results having high similarity to a user query among the first search result and the second search result may be processed as inputs of the second model 411b.

Meanwhile, when the second model 411b generates an answer by using at least one of the Semantic Search Result, which is a search result of the semantic retriever 411a-2b, and the IR search result, which is a search result of the information retriever 411a-1, the answer generation unit 432 of the prompt management unit 430 may generate an answer prompt for processing an answer generated at the second model 411b as an input of the large language model 413. The large language model 413 is input with an answer generated at a second model 411b, and further, information of a specified specific company may be input together. Meanwhile, when a first search query, a second search query, and a third search query examined above are obtained, the control unit 400 may input at least some of these to a second answer model 412 which is an FAQ Engine, and may obtain an answer (or a search result, a result value) for a user query. Into the second answer model 412, at least one of a second search query corresponding to a second category including a query reconstructed (or paraphrased) to have a meaning similar to the user query, or a first search query composed of keywords extracted from the user query, may be input. The second answer model 412, which is the FAQ Engine, based on an input search query, may search and provide an answer to a user query by using an answer to a standard query (e.g., frequently asked questions or expected queries).

In addition, an answer of the second answer model, which is the FAQ Engine 412, together with a user query, may be input to the large language model 413 and may provide a more natural answer to a user.

Meanwhile, as illustrated in FIG. 7 and FIG. 10, the answer generation unit 432 may generate an answer prompt (a part referred to by reference numeral 720) by using a large input model 413. An answer prompt generated at the answer generation unit 432, together with an answer generated at the second model 411b or an answer generated at the FAQ Engine 412, may obtain an answer prompt by inputting an Answer Prompt format according to FIG. 10(a) or (b) to the large input model 413. The answer generation unit 432, from the large input model 413, by extracting contents to be included in brackets “{ }” of the answer prompt format illustrated in FIG. 10(a) or (b) by using at least one of a user query, a first answer, and a second answer, may extract an answer prompt in which contents of the brackets “{ }” of the answer prompt format are filled with contents related to a user query and a specific company.

For example, an answer prompt format may be configured so that {company name} 1010 is filled, which is to configure an answer prompt to make a large language model generate only an answer about a specific company by using company data of the specific company when generating a final answer. For example, an answer prompt format may include “You are a chatbot who only answer questions about a company called {company_name}. Consider all words about the company(your company, this corporation, here, etc.) is talking about the company called {company_name}.” to specify a company name which is a target of answer generation. When a company name of a specific company is “42MARU”, the large language model 413, based on the answer prompt format, may generate an answer prompt including “You are a chatbot who only answer questions about a company called 42MARU. Consider all words about the company (your company, this corporation, here etc) is talking about the company called 42MARU.”. Meanwhile, it is needless to say that symbols included in the format, for example, “{ }”, may be variously modified into other symbols.

For another example, an answer prompt format may be configured so that {persona} 1020 is filled, which is for setting a persona of a speaker who utters a final answer generated from a large language model. A persona may be specified at a request of an administrator, or may be determined based on characteristics of the company. For example, in a case of a company developing artificial intelligence technology, a persona may be set to “a person in forties with a Ph.D. in engineering”. Further, a persona may be set differently for each characteristics of a user who has input a user query. In the unique information input together with a user query, user information (for example, ID, name, age, gender, and the like) may be included, and the large language model 413 may set a user-customized persona based on user information.

The large language model 413 may generate an answer differently in at least one of an answer-providing method, a format, and a tone by persona.

In addition, an answer prompt format may further include at least one of a date ({current date}, 1030) format that makes information of a date on which a user query is received or a date of another criterion be generated, a format for defining an answer format ({first_answer_format}, 1040, refer to FIG. 10(a)) in a case of generating an answer by using a first answer of a first answer model 411, a format for defining an answer format ({second_answer_format}, 1090, refer to FIG. 10(b)) in a case of generating an answer by using a second answer of a second answer model 412, and a format for specifying information ({reference}, 1050) about data that is a basis of an answer among company data. The large language model 413, based on the formats enumerated above, may fill {current date} 1030, {first_answer_format} 1040, {second_answer_format} 1090, and {reference} 1050 with data on the basis of a specific company, a user query about the specific company, a first answer generated from the first answer model 411, a second answer generated from the second answer model 412, and user information. Meanwhile, when an answer is generated from the first answer model 411, for example, from a second model 411b included in the first answer model 411, an answer prompt format may include only {first_answer_format} 1040 as illustrated in FIG. 10(a), and when an answer is generated from a second answer model, for example, an FAQ Engine 412, an answer prompt format may include only {second answer_format} 1090 as illustrated in FIG. 10(b).

According to {first_answer_format} 1040, a result generated at the large language model 413 may be generated as information defined about rules for generating an answer, for example, “include an answer of a second model 411b in a very first sentence”.

According to {second_answer_format} 1090, a result generated at the large language model 413 may be generated as information defined about rules for generating an answer, for example, “find an answer by using only information provided on a homepage”.

According to {second_answer_format} 1090, a result generated at the large language model 413 may be generated as information defined about rules for generating an answer, for example, “find an answer by using only information provided on a homepage”.

In addition to this, in an answer prompt format, at least one format that makes information related to a user query be filled, for example, {keywords_query} 1060 and {query} 1080 generated as a query prompt, and {passage_result} 1070 obtained through a first model 411a, may be included.

As examined above, the answer generation unit 432, based on an answer prompt format, may input to the large language model 413, together with an answer prompt format, at least one of a first answer of a first answer model 411, a second answer of a second answer model 412, a user query, specific company information, and user information, so as to complete an answer prompt that needs to be defined when generating an answer to a user query.

Meanwhile, when answers are respectively generated in different plurality of answer models, the control unit 400 may evaluate the generated answers, may select any one answer appropriate as an answer to a user query, and may input this to the large language model 413 together with an answer prompt format.

The control unit 400 may evaluate a first answer generated from the first answer model 411 and a second answer generated from the second answer model 412, and, based on an evaluation result, may select any one among the first answer and the second answer. Finally, any one answer selected may be input as a prompt of the large language model 413 and may generate an answer to a user query.

Meanwhile, the answer generation unit 432 may include, in a prompt format, any one of {first_answer_format} 1040 or {second_answer_format} 1090 according to whether a selected answer is generated at which model. That is, in a prompt format, characteristics of a model that generated an answer may be defined.

Meanwhile, as illustrated in FIG. 7, when an answer prompt is generated through the answer generation unit 432 and the large language model 413, information 720 including at least two among a user query, an answer prompt, and a context is input as a prompt to the large language model 413, and, as an output of the large language model 413, an answer 730 (a final answer) for a user query may be obtained. In this case, into the large language model 413, among answers generated by a plurality of answer generation models (for example, a first answer model 411 and a second answer model 412), a finally selected answer may further be input so as to be included. Here, a context, when an answer of the first answer model 411 is selected, includes at least one among a phrase (or a paragraph, a document,) among company data including a correct answer to a user query and location information thereof, and this may be information that is a basis of an answer generated at a second model 411b of the first answer model.

Meanwhile, the large language model 413 may be configured to generate an answer to a user query by using only results derived from a first model 411a and a second model 411b that generate an answer (or a correct answer) for a user query based on company data. Therefore, in a system according to the present invention, when generating an answer at the large language model 413, since an answer to a user query is not generated based on other data not derived from the first model 411a and the second model 411b, only accurate data about the company may be provided to a user.

Meanwhile, an answer (a final answer, answer, 730) for a user query obtained as an output of the large language model 413 may be variously configured according to a data format of an answer derived from the first answer model 411 or the second answer model 412. The large language model 413 may generate a user answer in a format corresponding to predefined rules according to a data format of an answer derived from the first answer model 411 or the second answer model 412.

For example, a large answer model(or a large language model), as illustrated in FIG. 9(a) and FIG. 9(b), when an answer to a user query 911 and 921 is composed of text, an answer may be made in a text format 912a and 922a. The large answer model may generate a user answer including reference information 912b and 922b that specifies what a portion that is a basis (or a source) of an answer is, together with an answer.

Further, although not illustrated, the large answer model may generate by using various formats such as a table, a list, numbering, an image, a video, interactive, a chart, a graph, a block diagram, a text listing, a source, and a link, according to at least one of requirements of a user, a format and contents of an answer, and search results of passage retrieval (or passage search).

For example, the large answer model, when a block diagram exists in search results according to passage retrieval (or passage search), may generate an answer format in a block diagram format. Further, the large answer model, when a user requests “show as a table,” may generate an answer in a table format.

Meanwhile, a system according to the present invention may analyze a user query and may provide a report for a specific company. A report may include various statistical information such as a ranking of user queries by period and a number of users using a chatbot.

Meanwhile, as illustrated in FIG. 6, an answer verification unit 433 may verify an answer of the large language model 413 by using a second model 411b. For example, in the present invention, it may be checked whether an answer extracted from a second model 411b is included in an answer of a large language model.

The prompt management unit 430 may, for a user query, compare an answer resulting from a second model 411b with an answer of the large language model 413, and may verify, through an answer verification unit 433, whether an answer resulting from the second model 411b is included in the answer of the large language model 413. For example, for a question of “What is the capital of the Republic of Korea?”, when the second model 411b outputs an answer of “The Republic of Korea is one of the countries in East Asia, and its capital is Seoul. (answer: Seoul).”, and the large language model 413 generates “The capital of the Republic of Korea is Seoul,” the answer verification unit 433 may verify the answer of the large language model 413 by checking whether “Seoul” is included in the large language model 413 answer. The answer verification unit 433, when the answer resulting from the second model 411b is included in the answer of the large language model 413, may determine that the answer of the large language model 413 is accurate. Conversely, the answer verification unit 433, when the answer resulting from the second model 411b is not included in the answer of the large language model 413, may determine that the answer of the large language model 413 is not accurate. In this case, the answer of the large language model 413 may be regenerated.

As described above, the method and system for providing an interactive communication agent service based on a generative AI model according to the present invention may, by using an answer model that has learned data of a company, with respect to a customer (or a user) query, provide a prompt and accurate answer to a customer.

Further, the method and system for providing an interactive communication agent service based on a generative AI model according to the present invention may, based on customer's query characteristics, for example, query intention and the like, by selectively using an appropriate answer model among a plurality of answer models, provide a more efficient and accurate answer to a customer.

Further, the method and system for providing an interactive communication agent service based on a generative AI model according to the present invention may, by specifying a correct answer to a customer's query from data of a company and by inputting this into a large model to generate an answer, provide a high-reliability company-customized answer to a customer.

In the present invention, a term of a model may be referred to as an engine or a “unit”, or a term of an engine may be referred to as a model or a “unit”.

Meanwhile, the present invention described above may be executed by one or more processes on a computer and implemented as a program that may be stored on a computer-readable medium (or recording medium).

Further, the present invention described above may be implemented as computer-readable code or instructions on a medium in which a program is recorded. That is, the present invention may be provided in the form of a program.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, optical data storage devices, and the like.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the alternations within the equivalent scope of the present invention belong to the scope of the present invention.

1. A method for providing an interactive communication agent service based on a generative artificial intelligence (AI) model in a system for providing an interactive communication agent service based on a generative AI model, the method comprising:
receiving a user query from a user terminal, in a state where a page associated with a company is provided to the user terminal;
specifying a specific company related to the user query by using unique information associated with the user query; and
generating an answer to the user query by using at least one among different plurality of answer models, based on characteristics of the user query,
wherein at least one among the plurality of answer models is a model that has been trained on the specific company before the user query is received by using data related to the specific company,
wherein the plurality of answer models comprises a first answer model and a second answer model different from the first answer model,
wherein the first answer model is a model that is trained by using data related to the specific company and generates an answer through a process of specifying correct answer data for the user query among data related to the specific company, and
wherein the second answer model is a model that generates an answer by using data in which a plurality of questions related to the specific company and an answer to each of the plurality of questions form sets with each other.

2. The method of claim 1, wherein the page associated with the company comprises a homepage of the specific company, and the user query is received through a chatbot provided by the specific company.

3. The method of claim 1, wherein the unique information comprises code information capable of specifying the specific company included in reception path information of the user query, and
wherein the specifying comprises:
specifying the specific company by using the code information included in the reception path information of the user query and company code matching information stored in a database of the system for providing an interactive communication agent service.

4. (canceled)

5. The method of claim 1, wherein the generating the answer comprises:
generating an answer to the user query by using a large language model (LLM) that receives, as a prompt, an answer generated from at least one of the first answer model and the second answer model; and
transmitting the generated answer to the user query to a channel that has received the user query.

6. The method of claim 5, wherein the data related to the specific company comprises at least one among data registered on a homepage of the company, a document uploaded to the system, a document collected from a server of the specific company, and a document collected from an external website in relation to the specific company, and
wherein the first answer model comprises a Retrieval-Augmented Generation (RAG) model that performs specifying of the correct answer data for the user query by using the data related to the specific company.

7. The method of claim 6, wherein the RAG model performs a passage search that specifies a portion related to the user query among the data related to the specific company in order to specify the correct answer data.

8. The method of claim 7, wherein the RAG model specifies a location of the correct answer data for the user query among the portions specified through the passage search, and
wherein a portion corresponding to the specified location among the portions specified through the passage search and location information about the specified location are input as a prompt of the large language model.

9. The method of claim 5, further comprising:
evaluating a first answer generated from the first answer model and a second answer generated from the second answer model;
selecting any one among the first answer and the second answer based on an evaluation result; and
inputting any one selected answer as a prompt of the large language model.

10. The method of claim 1, further comprising:
generating search queries for respectively deriving answers from the first answer model and the second answer model by using the large language model that receives the user query as a prompt,
wherein a first answer of the first answer model and a second answer of the second answer model are answers generated by receiving, as inputs, the search queries generated by using the large language model.

11. The method of claim 10, wherein the search queries comprises information included in at least one category among a first category including keywords extracted from the user query, a second category including a query paraphrased to have a meaning similar to the user query, and a third category including extended terms extended from a meaning of the user query.

12. The method of claim 11, wherein the first answer model comprises an information retriever and a semantic retriever, and comprises a re-ranker model that calculates a ranking for a search result of the first answer model and a search result of the second answer model.

13. The method of claim 1, wherein the user query is received through a virtual digital human trained by using data related to the specific company, and an answer to the user query is output as an utterance of the virtual digital human.

14. A system for providing an interactive communication agent service based on a generative artificial intelligence (AI) model, the system comprising:
a storage unit in which at least one computer program code is stored; and
a control unit configured to provide an interactive communication agent service based on the generative AI model, by using the storage unit and the program code,
wherein the control unit:
receives a user query from a user terminal, in a state where a page associated with a company is provided to the user terminal;
specifies a specific company related to the user query by using unique information associated with the user query; and
generates an answer to the user query by using at least one among different plurality of answer models, based on characteristics of the user query, and
wherein at least one among the plurality of answer models is a model that has been trained on the specific company before the user query is received by using data related to the specific company,
wherein the plurality of answer models comprises a first answer model and a second answer model different from the first answer model,
wherein the first answer model is a model that is trained by using data related to the specific company and generates an answer through a process of specifying correct answer data for the user query among data related to the specific company, and
wherein the second answer model is a model that generates an answer by using data in which a plurality of questions related to the specific company and an answer to each of the plurality of questions form sets with each other.

15. A program stored on a computer-readable recording medium, executed by one or more processes in an electronic device, the program comprising instructions for performing:
receiving a user query from a user terminal, in a state where a page associated with a company is provided to the user terminal;
specifying a specific company related to the user query by using unique information associated with the user query; and
generating an answer to the user query by using at least one among different plurality of answer models, based on characteristics of the user query,
wherein at least one among the plurality of answer models is a model that has been trained on the specific company before the user query is received by using data related to the specific company,
wherein the plurality of answer models comprises a first answer model and a second answer model different from the first answer model,
wherein the first answer model is a model that is trained by using data related to the specific company and generates an answer through a process of specifying correct answer data for the user query among data related to the specific company, and
wherein the second answer model is a model that generates an answer by using data in which a plurality of questions related to the specific company and an answer to each of the plurality of questions form sets with each other.
